(19) United States
(12) Patent Application Publication
(10) Pub. No.: US 2024/0258093 A1
(43) Pub. Date: Aug. 1, 2024

(54) AN ELECTRON IMPACT IONIZATION WITHIN RADIO FREQUENCY CONFINEMENT FIELDS

(71) Applicant: QuadroCore Corp., Markham (CA)

(72) Inventors: Gholamreza Javahery, Thornhill (CA); Fadi Jozif, North York (CA); Babak Shahabi, Toronto (CA); Farshid Pashaee, Richmond Hill (CA)

(21) Appl. No.: 18/578,707

(22) PCT Filed: Jul. 11, 2022
(86) PCT No.: PCT/CA2022/051076

§ 371 Date: Jan. 11, 2024

Related U.S. Application Data
(60) Provisional application No. 63/220,718, filed on Jul. 12, 2021.

(51) Int. Cl. H01J 49/14; G01N 30/72; H01J 49/06

(52) U.S. Cl. CPC H01J 49/147; G01N 30/7206; H01J 49/063; H01J 49/067

(57) ABSTRACT

The present system is a filament and an ion guide configuration. The ion source and an ion guide are combined in one system to create a fast release of ions, with increased efficiency of ion transport. The present device is a high-efficiency ion source operating at very low up to a few Torr pressure. Ions generated from the source immediately introduced into or created in an ion guide. The ions are introduced in or around the zero field lines of the RF field. Therefore, they will be trapped under the influence of the RF field there and can be transported to the next region of the mass spectrometer device. One method of transferring ions is by using ion-guides. Multipole ion guides have efficiently transferred ions through a vacuum or partial vacuum into mass analyzers. In particular, multipole ion guides have been configured to transport ions from a higher pressure region of a mass spectrometer to the lower pressure and then vacuum where the analyzer is operational.

### FIELD OF THE INVENTION

The present invention generally relates to an apparatus for and method of an ion source to produce a high yield of ions and capture them in an RF only ion guide.

### BACKGROUND OF THE INVENTION

Mass spectrometers (MS) are used to determine molecular weight and structural information about chemical compounds. Molecules are weighed by ionizing the molecules and measuring the response of their trajectories in a vacuum to electric and magnetic fields. Ions are weighed according to their mass-to-charge (m/z) values. In order to achieve this, a sample that is to be characterized, is ionized and then injected into the mass spectrometer. The sensitivity of a mass spectrometer, in part, directly depends on the efficiency of the ion source for generating high yields of desired ion of interest.

Electron impact (EI) and chemical ionization (CI) are widely used for the generation of a high yield of gas phase ions. EI is, theoretically, capable of ionizing all organic gas phase compounds. The practical limitations arise from vaporizing the sample in the source. Highly involatile compounds with large or very polar molecules cannot be evaporated from a probe, while thermally labile substances decompose on heating. EI is the classical ionization method in MS. The sample for analysis is introduced into the ion source (held under high vacuum, 10⁻⁷ to 10⁻⁵ mbar) from a reservoir (in the case of gases and volatile liquids), or a heated probe (for involatile liquids and solids), or as the eluent from a GC. It is essential that the sample enters the ion source in the gaseous state. The ability to heat the source and solids are essential to successful sample analysis.

The methods to generate EI ions rely on the formation of an electron beam energized and directed into an ionization chamber where gas phase samples are introduced. Energized electron beam entering the ionization chamber can generate positively or negatively charged ions. Generally, electrons with above 70 eV in collision with a gaseous sample result in striping one or more electrons from atoms or molecules within the sample. This process results in the creation of predominantly positively charged ions plus free electrons, known as the electron detachment process. For a generation of negatively charged ions, electron energy is reduced to less than 50 eV. Under this condition, electrons are susceptible to attach to the atom and molecules within the sample, and as a result, the majority of ions formed are negatively charged. This process is known as electron attachment.

Sample molecules collide with high-energy electrons (typically about 70 eV), produced by a glowing filament of resistive materials such as tungsten or rhenium. If the energy transferred exceeds the molecules' ionization energy, ions are formed. Typically, pressure in the ionization region is optimized for maximum analyte ions of interest and prevents the analyte ion from further reacting through ion/molecule reaction. In some cases, the impact of an energetic electron dissipates enough energy within the structure of the analyte molecules and causes it to fragment. Fragile and larger molecules naturally fragment more readily, resulting in limited production of the intact ion of interest. This in effect, reduces the sensitivity of the MS device and in turn, poor direct quantitation of the analyte. Although, EI source is known to produce high yields of ions but requires elaborate design. The extraction of ions from the ionization region is challenging and complex. Present EI sources require frequent cleaning and retuning, reducing the uptime of the MS device.

Another ionization mode is chemical ionization (CI). CI is capable of ionizing a wide range of organic molecules, although ionization efficiency varies greatly, depending upon the type and degree of functionalization. Molecules that support protonation work best, whereas hydrocarbons and haloalkanes ionize very poorly. Chemical Ionization is similar to the classical EI but the knowledge and results of ion-molecule reactions are exploited. CI is carried out in an ion source similar to that used for EI. The principal difference between the two techniques is the presence of a CI reagent gas during operation in the CI mode (typically ammonia, methane, or isobutene). Dedicated CI sources also tend to have a narrower exit slit to maintain a higher CI gas pressure in the inner source (10⁻³-1 mbar). Electrons from the filament ionize the CI gas in an EI source. The ions produced undergo various possible ion-molecule reactions with the sample molecules present to enhance the abundance of the CI molecular ion.

Some compounds may produce negative ions under the right conditions. Negative ions may form by ion-molecule reactions between sample and reagent gas ions. Such reactions include proton transfer, charge exchange, nucleophilic addition, or nucleophilic displacement. Moreover, the capture of the thermal electrons generated under CI conditions allows for the formation of molecular anions from compounds with a positive electron affinity. The electron energy is very low, and the specific energy required for electron capture depends on the molecular structure of the analyte. Electron attachment is an important mode of formation of negative ions, which frequently is used in CI. Negative ions are produced as a result of electron-molecule interactions by three general processes:

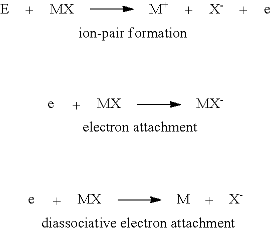

An EI positive ion formation may comprise of the following process:

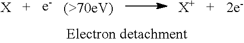

in which an electron collides with the molecule and releases two electrons.

Normally, EI's design is different from that of CI source, and therefore, two different sources are required for a physical exchange. EI negative ion formation comprises of the following process:

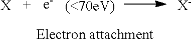

in which an electron collides and attaches to the molecule, making a negatively charged ion. And the CI ion formation comprises of the following process:

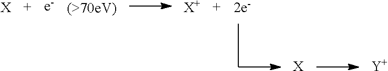

in which electron detachment is followed by secondary reaction of analyte ion with analyte neutral. In this chemical ionization, there is an ion with its neutral. Chemistry has to happen for this to from. In electron attachment followed by secondary reaction of analyte ion with analyte neutral, the same reaction as above occurs, but attachment happens:

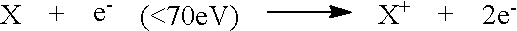

The benefits of negative CI (NCI) are efficient ionization, higher sensitivity, and less fragmentation than positive-ion EI or CI. There is also a greater selectivity for certain environmentally or biologically essential compounds. The limitations are that not all volatile compounds produce negative ions and poor reproducibility of the measurements.

EI and CI sources have been commercially available for many years as a separate device. It is of particular importance that both EI and CI sources can easily be coupled with capillary gas chromatography (GC), thus combining the high separation efficiency of GC with the high sensitivity and specificity of mass spectrometry (MS). Whereas EI is an energetic ionization technique, CI is a softer ionization applied to volatile samples where no or a very small molecular ion is observed due to excessive fragmentation. EI & CI have been used in generating ions from gas phase samples, as in IE GC-MS/MS. Generally, hard ionization is the only choice for +ve ion generation, e_{nergy}>70 eV. In this process, an electron is stripped off the molecule and a positive ion is formed. Values of less than 50 eV result that the electron attaches to the molecule, and it becomes negative. Ions created by the direct impact of the electron are called EI ions. CI ions are created through secondary and tertiary reactions provided that the condition for reaction time is appropriately short:

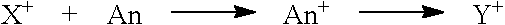

In this process, there is a limited ionization efficiency for molecules with high electron affinity and there is an inability to produce a high yield of intact ions, especially in +ve mode. Larger molecules undergo more fragmentation, and they possess more degrees of freedom. Fragile molecules fragment readily under energetics e bombardment. This results in the formation of a low yield of intact ions and low sensitivity. Lack of intact ions results in poor quantitation work, poor limit of detection (LOD) & limit of quantitation (LOQ). In addition, the integrity of a molecular structure is unknown; there is internal excess energy and complicated ion extraction and transmission. EI-MS or CI-MS require two or more pumping configurations.

EI and CI methods can be used if the compound to be studied is sufficiently volatile and stable to be vaporized intact. Although both methods can generate a high yield of ions, which are necessary in mass spectrometry specifically, there are serious setbacks. Generating the high yields of positive ions requires high energetic electrons, which in turn has some negative consequences. These include: (1) Causing fragmentation of molecule ions of interest. The degree of fragmentation depends on the size and structure of the molecule. Generally, bigger molecules are susceptible to more fragmentation compared to impact and small molecules. (2) Limited generation of the intact ions results in poor quantitation, reducing detection limit. (3) Fragile molecules naturally fragment too easily. (4) Because of available excess energy, the integrity of the molecule's structure usually is unknown. (5) Ion extraction from ionization chamber is a challenging endeavour and requires elaborating and complex design consideration, adding to complexity and expense. (6) They require frequent expert tuning and cleaning, reducing up time.

In many cases, EI and CI sources are separately manufactured and require physical exchange. Mounting a new source normally requires (1) time and expertise, reducing up time of the instrument, and (2) reproducibility is challenging.

Since mass spectrometers generally operate in a vacuum (maintained lower than 10⁻⁴ Torr depending on the mass analyzer type), charged particles generated in a higher pressure ion source must be transported into a vacuum for mass analysis. Typically, a portion of the ions created in the pressurized sources are entrained in a bath gas and transported into a vacuum. Doing this efficiently presents numerous challenges.

The use of RF multipole ion guides—including quadrupole ion guides, ring guides and ion funnel—has been shown to be an effective means of transporting ions through a vacuum system. A simplest RF multipole ion guide is usually configured as a set of (typically 4, 6, or 8) electrically conducting rods spaced symmetrically about a central axis with the axis of each rod parallel to the central axis. Ions enter the ion guide, experience the RF confinement fields, and intend to move to the central axis of the ion guide. However, in ion guides operating in an elevated pressure, ions are susceptible to collide with the background gas. Hence, because of collision, they lose a portion of their translational and radial energy including internal energy. The phenomena known as collisional focusing make ions bundle more effectively to the centerline of the ion guide and therefore transported to the exit in high abonnement.

### SUMMARY OF THE INVENTION

The present system is a filament and an ion guide configuration. The ion source and an ion guide are combined in one system to create a fast release of ions, with increased efficiency of ion transport. The prior art generally applies an extraction voltage to the chamber to cause emission of ions from the chamber. The present system is configured to directly guide the ions into the ion guide.

The present device is a high-efficiency ion source operating at very low up to a few Torr pressure. Ions generated from the source immediately introduced into or created in an ion guide. The ions are introduced in or around the zero field lines of the RF field. Therefore, they will be trapped under the influence of the RF field there and can be transported to the next region of the mass spectrometer device. One method of transferring ions is by using ion-guides. Multipole ion guides have efficiently transferred ions through a vacuum or partial vacuum into mass analyzers. In particular, multipole ion guides have been configured to transport ions from a higher pressure region of a mass spectrometer to the lower pressure and then vacuum where the analyzer is operational.

The RF only ion guide is also a suitable environment for ion/molecular reactions. There are numerous advantages namely, quenching the energy of the meta-stable molecules by the introduction of a suitable reagent into the device.

Ions created as a result of this process can be unstable within the boundary of RF field or easily filtered by the mass analyzer. Ion guide can act as a reaction cell where ion/molecular reaction occurs for generating ions by soft ionization. It can also be used as a collision cell where ions undergo fragmentation or declustering process, forming more intact ions of interest and gain axial and radial acceleration.

The present system has achieved the following objectives:
One object of the present invention is to provide an electron impact ion source that can make negative and positive ions in high abundance in one source.
Another object of the present invention is EI source which is very simple comprising a filament and electron pusher and extractor lenses.
Another object of the present invention is the EI source is mounted on or close to an RF only ion guide so that all ions generated by the electron impact would be captured within the RF confinement field of the ion guide.
Another object of the present invention is capability of producing high yields of ions by method of soft or hard ionization.
Another object of the present invention is generating high yields of CI ions within the provided ion guide.
Another object of the present invention is to provide an electron impact ion source that creates high yields of intact ions of interest by creating atomic or molecules ions and interact them with analyte within the provided ion guide via charge transfer chemical reaction.
Another object of the present invention is to provide an electron impact ion source with adjustable electron energy to control the degree of ion fragmentation.
Another object of the present invention is to provide a system that EI and CI ions are formed in one source.
Another object of the present invention is to provide an electron impact ion source that is flexible with high capabilities, including multiplexing to operate in conjunction with multiple GC's.
Another object of the present invention is to provide an electron impact ion source that is compatible with GC output flow rate and requires no splitting, and it is easy to build, operate and maintain.
·Another object of the present invention is to provide a system the sample is introduced at a certain pressure, and it interacts with the mass spectrometer such that the MS does not stay idol.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A shows the first embodiment of the present system;

FIG. 1B shows the front view the first embodiment of the present system;

FIG. 2 shows the second embodiment of the present system;

FIG. 3 shows the third embodiment of the present invention;

FIG. 4 shows the fourth embodiment of the present invention;

FIG. 5A shows the fifth embodiment of the present invention;

FIG. 5B shows the cross view of the fifth embodiment of the present invention;

FIG. 6A shows the sixth embodiment of the present invention;

FIG. 6B shows the cross view of the sixth embodiment of the present invention;

FIG. 7 shows the seventh embodiment of the present invention;

FIG. 8 shows the eighth embodiment of the present invention;

FIG. 9 shows the ninth embodiment of the present invention, and

FIG. 10 shows the tenth embodiment of the present invention.

### DETAILED DESCRIPTION OF THE INVENTION

Prior art EI ion sources generally comprise of an electron beam that is generated by a filament. The electron beam is introduced into an ionization chamber, where analytes are introduced. As the analyte molecules occupy the chamber, they are bombarded by the electron beam forming ions. The chamber may be equipped with repellers, electron collectors, and accelerators to generate an ion beam out of the chamber. There may be a set of lenses to collect and focus ions, and accelerate them by a set of focusing electrodes, set in front of the ionization chamber, and towards an ion guide and then into a mass spectrometer. Generally, the ionization region is pressurized injecting ions into vacuumed ion guide. B it is possible to generate CI ions governed by chemistry. By controlling the pressure inside the ionization chamber, ions governed by CI can also be generated.

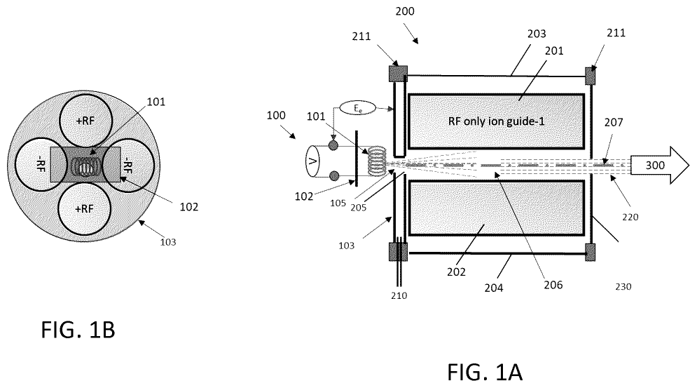

In the present system, the electron beam is directed right into an ion guide. FIGS. 1A and 1B show the first embodiment of the present system to create a high yield of EI ion source. The system comprises of an electron source 100, which comprises of a filament 101. It may also include a repeller 102 and an exit lens 103. The electron source generates an electron beam 105 that is directly aimed at the entrance 205 of a RF ion guide 200.

The RF ion guide 200 comprises of a set of rods 201, 202 sandwiched between two electrodes 203, 204. This is an enclosed system using a set of insulators 211, sustaining pressure up to 10 torr. It has a sample inlet port 205 to allow samples to enter the ionization region 206. The ionization occurs either inside of the RF confinement field or in its close vicinity. The confinement of the RF field captures ions created through electron impact.

The electron beam is injected along an axial center line 207 of ion guide with a given energy. Analytes are injected through a first inlet 210 which introduces them at the entrance of the RF ion guide in such a manner that the electron beam 105 will carry them into the RF ion guide 200 and the ionization occurs inside the RF field of the ion guide. Therefore, almost all ions generated by the EI are captured by the ion guide. The electrons that enter the RF field may obtain energy and get ejected. In the way out, they may impact molecules and cause the generation of further ions. The analyte inlet flow is configured to prevent disturbance of the electron beam. In one embodiment, the inlet flow is set to around 1 microliter per minute. In addition, the vacuum level of the RF ion guide is configured to control the ionization process. The ion beam 220 generated inside the RF ion guide 200 is passed through one or more exit lens 230 and towards a mass spectrometer (MS) 300. Electrons under the influence of RF field are unstable and gain energy rapidly, assisting ionization further. Electron energy gain is around 70.0 eV, good enough to ionize most compounds in +ve mode. Analytes are introduced from first inlet 210 into the ion guide 250 at the entrance, where an electron beam 205 is introduced. Interaction of electrons with analytes occurs within RF confinement field, resulting in the capture of a high yield of analyte ions. An axial field might be provided for the ion guides for exiting ions. The electron energy is reduced for the formation of negative ions.

The first inlet may be directly connected to the exit port of a gas chromatography system (GC). The RF ion guide is sustained at a pressure by direct sample introduction or connection to a GC output.

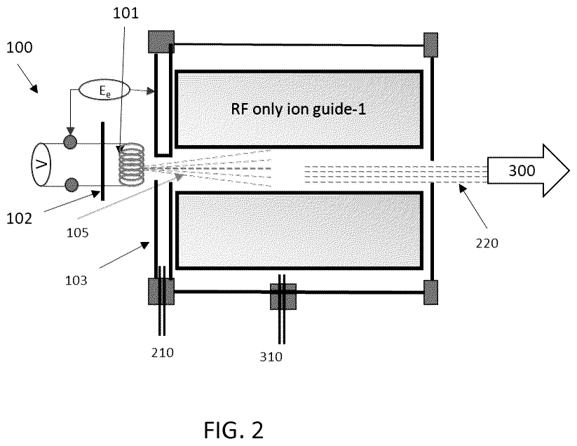

FIG. 2 shows a second embodiment of the present system for soft ionization. It has two inlets, one for atomic gases and one for analytes and other gases. Atomic gases do not fragment easily through electron bombardment within the energies used in these systems. Atomic gases are introduced through the first inlet 210, which are ionized by the electron impact and then captured in the RF field. Analytes are introduced in second inlet 310, which exchange charges with the charged atoms, which pass the charge to analytes of interest, resulting in soft ionization with no access energy. The electron has no other energy except the internal energy that can be used of soft ionization. The following example shows the process.

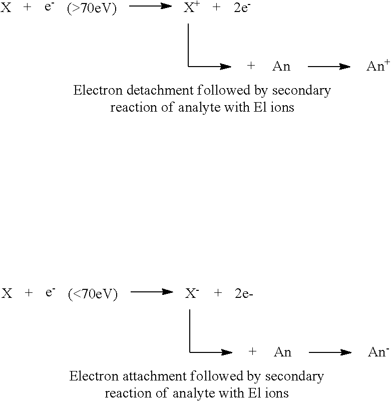

The present system allows for having both EI and CI ions in one source. It comprises of the following. EI source is placed at the entrance of the RF ion guide. The RF ion guide is sustained at a pressure by direct sample introduction or by connection to a GC output via the second inlet plus makeup gasses. The electron beam is focused into the axial center of the ion guide with a given energy. Electrons under the influence of RF field become unstable and gain energy rapidly, assisting ionization further. Electron energy gain is around 70.0 eV, good enough to ionize most compounds in +ve mode. Inert or any other appropriate gasses that ionize readily by electron impact can be introduced from the first inlet 210 into the ionization region at the entrance where the electron beam is introduced. Interaction of electrons with atoms or molecules occurs within RF confinement field, resulting in a high yield of positive or negative ions. Analytes are introduced from the second inlet 310. Ions that created and captured by the RF field upstream of the ion guide can react with the analyte via ion/molecule reaction and become ionized with high efficiency within the RF field of the ion guide.

In some cases, other neutral inert gasses (makeup gas) can be introduced into the ion guide for CI ion generation. In such cases, the ions created with electron impact are more susceptible to react with the analyte of the interest, and the analytes become ionized. This process can provide smaller mean free path that govern the gas phase ion chemistry, and better collisional focusing. Analyte ions normally lose radial and axial energy in collision with inert neutral. As a result they move to the centerline of the ion guide under the influence RF field. This phenomena is known as the collisional focusing. Since the initial ions are cooled by collision, the only access energy via a charge transfer reaction with the analyte would be the exothermicity of the reaction. For example, a typical exothermic ion molecular reaction is: X^{±}+An→An^{±}+X+ΔE. Reaction appropriately can be designed to minimize the exothermicity energy, preventing fragmentation of the analyte ions. In this way, high yields of intact ion of interest can produce. Possible reactions are summarized in table 1. An axial field may be provided for the ion guides for exiting ions. CI ions are formed easily by elevating the pressure of the ion guide to a desired level to obtain the exothermic energy ΔE. Table 1 shows some of the possible ion reactions. For example, charge transfer can happen between A⁺ and B, if the ionization of A's energy is larger than that of B. On the other hand, we have electron transfer, which is governed by electron affinity. This may happen in the second reaction when the electron affinity of B is larger than that of A. The third reaction shows the proton transfer, which is governed by the proton affinity. The fourth reaction shows an adduct formation. The fifth reaction shows the cluster formation. The six reaction shows an ion dissociation reaction, and the last reaction is a generally allowed reaction.

TABLE 1
Possible ion chemsitry

| | | | | |
|---|---|---|---|---|
| A⁺ + B | → | B⁺ + A + ΔE | IE(A) > IE(B) | charge Transfer |
| A⁻ + B | → | B⁻ + A + ΔE | EA(A) < EA(B) | electron Transfer |
| AH⁺ + B | → | BH⁺ A + ΔE | PA(A) < PA(B) | Proton Transfer |
| A⁺ + B | → | [A · B]⁺ + ΔE | | Adduct formation |
| A⁺ + BC | → | AB⁺ + C + ΔE | | Cluster Reaction |
| AC⁺ + B | → | A⁺ + C + B + ΔE | | Ion Dissociation |
| AC⁺ + BDE | → | Products | | allowed chemistry |

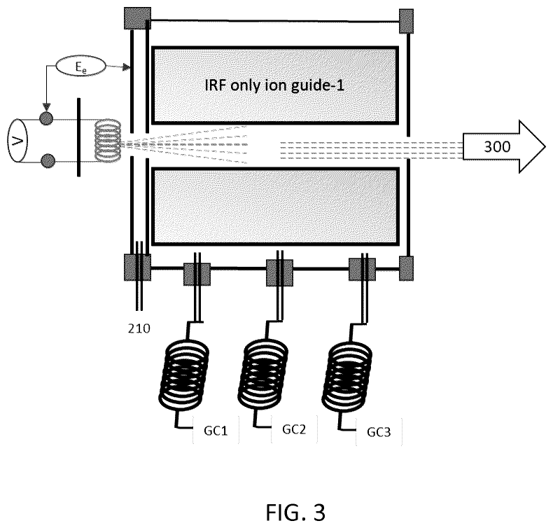

FIG. 3 shows a third embodiment of the present system for soft ionization and multiplexing. In this embodiment, multiple GC's (GC1, GC2, GC3) are connected to the RF ion guide and they are synchronized with the system to increase throughput. This allows for sequential ionization.

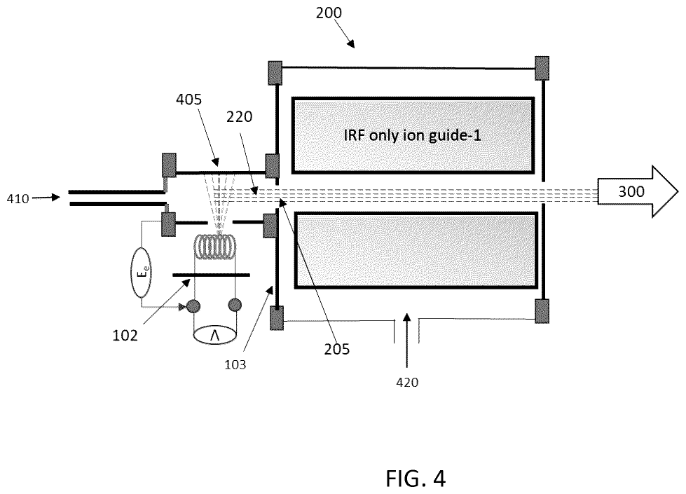

FIG. 4 shows the fourth embodiment of the present system for EI ions creation in isolation. An isolated ionization chamber 404 is mounted at the entrance of the ion guide 205. EI ion bean 220 is created in the ionization chamber 404 and is directed into the ion guide 200. For transmitting the EI ions, the ion guide acts as a breaker, focusing and collimating the ion beam. For soft ionization, atomic gasses are introduced from the first inlet 410, atomic ions are created through electron impact in the ionization region and then directed into the ion guide Samples are introduced through the second inlet 420 from a GC or directly into the RF ion guide where atomic ions are transmitting. Ionizing appropriate ions generate CI ions by electron impact in the ionization region then undergo ion molecule reaction within the ion guide. Ion guide may be pressurized to an appropriate pressure by aid of additional inert gas. The analyte of interest will be ionized through ion molecule reaction predominately charge transfer from the EI atomic ions. Axial field might be provided for the ion guides for exiting ions. CI ions are formed easily by elevating the pressure of the ion guide to a desire level.

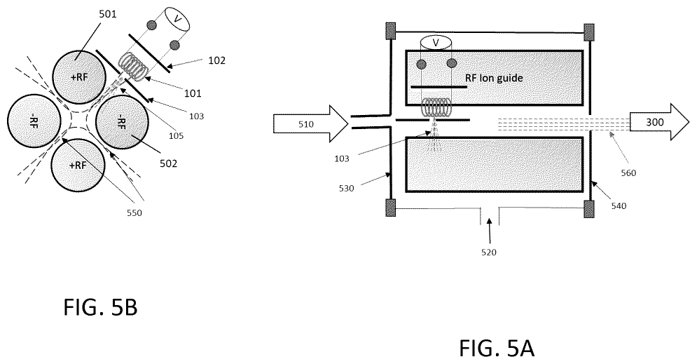

FIGS. 5A and 5B show the fifth embodiment of the present system. In this embodiment, the electron source is placed inside the RF ion guide that is confined by an end cap 530 and an exit lens 540. The filament 101, the repeller 102, and the exit lens 103 of the electron source are placed in between the rods 501, 502 of the RF ion guide 500 and configured to generate an electron beam that is aligned with the zero filed 550 of the RF ion guide. Therefore, the ions formed are immediately captured in the field and manipulated as desired. Samples are provided through the first inlet 510 and the second inlet 520. The ion beam 560 is taken to the MS.

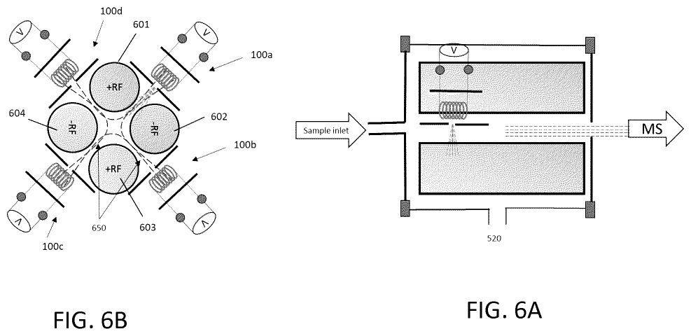

FIGS. 6A and 6B shows the sixth embodiment of the present system, which is similar to the fifth embodiment, but it has multiple electron beam sources, each placed between the two neighboring rods of the RF ion guide. For example, electron beam source 100a is placed rods 601 and 602, electron beam source 100b is placed rods 602 and 603, electron beam source 100c is placed rods 603 and 604, and electron beam source 100d is placed rods 604 and 601. The electron beams are introduced into the zero fields 650 of the RF ion guide. This embodiment increases the system sensitivity or uptime, and allows for increasing production of the EI.

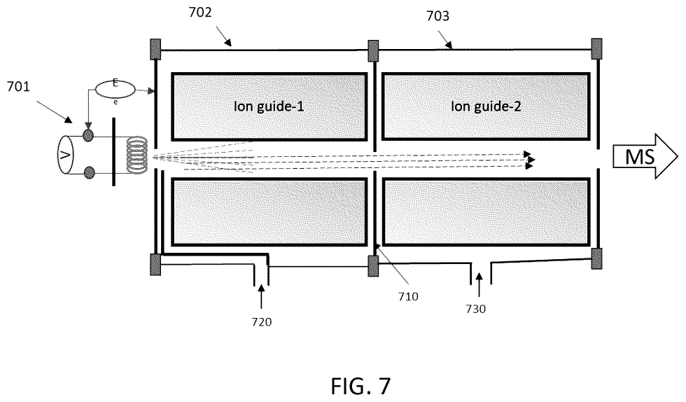

FIG. 7 shows the seventh embodiment of the present invention. This embodiment comprise of two segmented ion guides for soft ionization, creating a high yield of intact ions. The elector source 701 is placed at the entrance of the first ion guide 702. The first ion guide 702 is sustained at a desired pressure (normally mTorr) by introducing inert makeup gases such as Ar, He, N₂, and others. The second ion guide 703 that may be separated from the first ion guide by an inner lens 710 is pressurizes by leakage from the first ion guide 702. The analyte are introduced from the first inlet 720 directly or by connecting to a GC outlet. Ionization occurs within the RF confinement field of first ion guide. The ions from the first RF ion guide then enter the second ion guide. There may be a second inlet 730 to introduce new analytes. The ions are then directed to the MS.

Atomic ions are known to be efficiently ionized by electron impact. In this case, atomic ions (such as He⁺, Ar⁺, etc.) are formed in the first ion guide and directed into the second ion guide, where analyte of the interest has been introduced. Analytes ionize through gas phase chemical reaction of the atomic ion and the analyte. This is a very soft process of ionization, therefore, intact analyte ions are formed in a high yield. An axial field may be provided to accelerate exiting ions. Alternatively, ions are formed in the first ion guide and undergo gas phase chemical reaction in the second ion guide to form secondary ions.

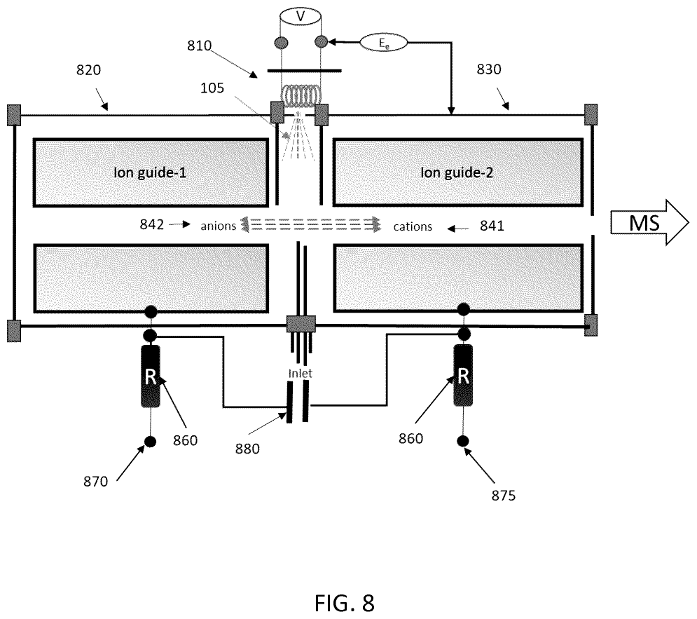

FIG. 8 shows the eighth embodiment of the present system for a two segmented ion guides, wherein the electron source 810 is placed in between a first 820 and a second 830 RF ion guides. The system is configured to separate the positive 841 and negative 842 ions. The first and second RF ion guides are configured with RF blocking resistors 860, DC rod offsets 870, 875, and a coupling Capacitor 880. In this case, the inlet 850 is also placed in between the two RF ion guides, and the negative and positive ions are generated and are immediately separate.

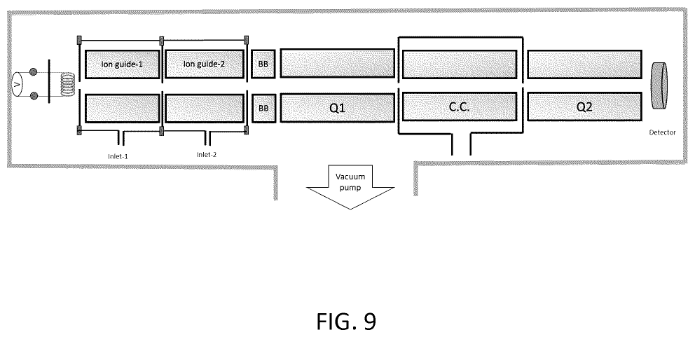

FIG. 9 shows the ninth embodiment of the present system for EI-MS with one pump configuration. The system comprises of a first ion guide that is sustained at a few Torr of pressure by introducing makeup gas such as Ar, He, N₂, and others. A second ion guide placed in front of the first ion guide is pressurized by leakage from the discharge tube and sustained at a few mTorr. Analytes are introduced from the first inlet directly or by connecting to a GC outlet. Analytes are ionizes within the RF confinement field of the first ion guide, and then enter into the second ion guide before directed to the MS. Alternatively, ions created in the discharge tube introduced into the ion guide and analyte via the second inlet. Analyte will be ionized through ion/molecular reaction in the second ion guide. Axial field might be provided for the ion guides for exiting ions. This is an example of how the system is used in a one pump configuration.

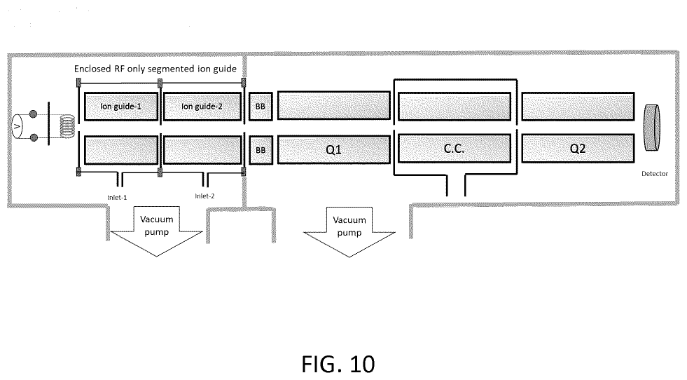

FIG. 10 shows the 10^{th} embodiment of the present system for EI-MS with two pumps configuration. The first ion guide is sustained at a few Torr of pressure by introducing makeup gas such as Ar, He, N₂, and others. The second ion guide is pressurized by leakage from the discharge tube and sustained at a few mTorr. Analyte are introduced from the first inlet directly or by connecting to a GC outlet. Ionization occurs within RF confinement field of the first ion guide, and then the ions are introduced into the second ion guide before directed to the MS. Alternatively, ions created in the discharge tube introduced into the ion guide and analyte via the second inlet. Analyte will be ionized through ion/molecular reaction in the second ion guide. Axial field might be provided for the ion guides for exiting ions.

1-19. (canceled)

20. An electron impact (EI) ion source, comprising:
a) a RF ion guide having an entrance, an axial centerline, and an axial field to guide ions;
b) an electron source comprising of a filament generating an electron beam, an electron repeller, and an exit lens, wherein the electron beam is aligned along the axial centerline of the RF ion guide; and
c) a first inlet placed at the entrance of the RF ion guide to introduce analytes, wherein the electron beam is configured to interact with the analytes within RF confinement field to generate an ion beam.

21. The EI ion source of claim 20, wherein the inlet flow is about 1 microliter per minute.

22. The EI ion source of claim 20, wherein the RF ion guide is a RF quadrupole.

23. The EI ion source of claim 20, the electron beam is configured to provide an electron energy gain of around 70.0 eV, and wherein the ion guide accelerates the electron beam to energy between about 25 eV and about 70 eV.

24. The EI ion source of claim 20, further comprising:
d) a second RF ion guide having a second entrance, a second axial centerline, and a second axial field to guide ions, positioned so the second axial centerline is the same as the first axial centerline and the exit of the first RF ion guide lines up with the entrance of the second RF ion guide; and
e) a second inlet to introduce analyte into the second RF ion guide.

25. The EI ion source of claim 24, where the first RF ion guide is pressurized by the introduction of atomic or inert gases, and the second RF guide is pressurized by leakage from the first RF ion guide.

26. An electron impact (EI) ion source, comprising:
a) a RF ion guide having an entrance, an axial centerline, and an axial field to guide ions;
b) an electron source comprising of a filament generating an electron beam, an electron repeller, and an exit lens, wherein the electron beam is aligned along the axial centerline of the RF ion guide;
c) a first inlet placed at the entrance of the RF ion guide to introduce inert or atomic gases;
d) a second inlet placed in the RF ion guide to introduce analytes;
e) wherein the first inlet and the RF ion guide are configured so the inert or atomic gases are ionized by the electron beam creating ionized inert or atomic gases; and
f) wherein the second inlet and RF ion guide are configured so that the analytes are ionized by the ionized inert or atomic gases through an ion/molecular reaction and result in a soft ionization of the analytes.

27. The EI ion source of claim 26, wherein the second inlet receives the analytes from a gas chromatography system (GC).

28. The EI ion source of claim 27, where there are a plurality of second inlets connected to a plurality of gas chromatography systems.

29. The EI ion source of claim 28, where the plurality of gas chromatograph systems are configured to allow increased throughput.

30. The EI ion source of claim 28, where the plurality of gas chromatograph systems are configured to allow sequential ionization.

31. An electron impact (EI) ion source, comprising:
a) a RF ion guide having an entrance, an axial centerline, and an axial field to guide ions;
b) an electron source comprising of a filament generating an electron beam, an electron repeller, and an exit lens, wherein the electron beam is introduced directly into the RF ion guide through a zero field of the RF field;
c) a first inlet into the RF ion guide to introduce a first analytes, wherein the electron beam is configured to interact with the first analytes within the RF confinement field to generate an ion beam of ionized first analytes.

32. The EI ion source of claim 31, further comprising a second inlet into the RF ion guide for introducing a second analytes, wherein the RF ion guide and the second inlet are configured so that the second analytes are ionized by the ionized first analytes resulting in a soft ionization of the second analytes.
